(19) United States
(12) Patent Application Publication
(10) Pub. No.: US 2011/0077989 A1
(43) Pub. Date: Mar. 31, 2011

(54) SYSTEM FOR VALUATING EMPLOYEES

(75) Inventors: John M. Akred, Lake Forest, IL (US); Marc A. Sotkiewicz, Chicago, IL (US)

(73) Assignee: Accenture Global Services Limited, Dublin (IE)

(21) Appl. No.: 12/890,312

(22) Filed: Sep. 24, 2010

Related U.S. Application Data
(60) Provisional application No. 61/245,452, filed on Sep. 24, 2009.

(51) Int. Cl. G06Q 10/00

(52) U.S. Cl. 705/7.38

(57) ABSTRACT

A system is described for valuating employees. The system may include a memory and a processor. The memory may store a historical dataset which describes employees of an organization. The historical dataset may include inputs describing employee performance over a time interval. The processor may be operatively connected to the memory and may receive the historical dataset. The processor may identify a value metric which describes the value contributed by each employee to the organization over the time interval. The processor may analyze the historical dataset to identify a subset of the inputs which are indicative of the value metric over the time interval. The processor may generate a predictive model based on the subset of the inputs and the value metric. The predictive model may determine a net present value of each employee indicative of an expected value to be contributed by each employee over a future time interval.

### RELATED APPLICATIONS

The present patent document claims the benefit of the filing date under 35 U.S.C. §119(e) of Provisional U.S. Patent Application Ser. No. 61/245,452, filed Sep. 24, 2009, which is hereby incorporated in its entirety by reference.

### TECHNICAL FIELD

The present description relates generally to a system and method, generally referred to as a system, for valuating employees, and more particularly, but not exclusively, to determining an employee's net present value to an organization based on the predicted value of the employee to the organization over a time interval, such as five years, ten years, or the course of the employee's career.

### BACKGROUND

Human capital may be a major source of competitive advantage for an organization. Studies have shown that human capital may be the most important factor for maintaining an organization's long term competitive advantage in the marketplace. Accordingly, it may be desirable for an organization to identify the employees who may contribute the most value, and conversely the least value, to the organization over the course of their career. The organization may wish to devote additional resources, such as training and mentoring, to the employees who may contribute the most value, while devoting fewer resources to the employees who may contribute the least value.

### SUMMARY

A system for valuating employees may include a memory, an interface, and a processor. The memory may be connected to the processor and the interface and may store a historical dataset which describes the employees of an organization over a time interval. The historical dataset may include inputs describing the performance of each employee over a time interval. The processor may be operatively connected to the memory and may receive the historical dataset. The processor may identify a value metric which describes the value contributed by each employee to the organization over the time interval. The processor may analyze the historical dataset to identify a subset of the inputs which are indicative of the value metric over the time interval. The processor may generate a predictive model based on the subset of the inputs and the value metric. The predictive model may determine a net present value of each employee indicative of an expected value to be contributed by each employee over the course of a future time interval equivalent to the time interval.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for valuating employees.

FIG. 2 is a block diagram of a network environment implementing the system of FIG. 1 or other systems for valuating employees.

FIG. 3 is a flowchart illustrating the generation of a predictive model for valuating employees in the system of FIG. 1 or other systems for valuating employees.

FIG. 4 is a flowchart illustrating the generation of employee value weightings in the system of FIG. 1, or other systems for valuating employees.

FIG. 5 is a flowchart illustrating the generation of predictive employee values in the system of FIG. 1, or other systems for valuating employees.

FIG. 6 is a graph demonstrating employee value points in the system of FIG. 1, or other systems for valuating employees.

FIG. 7 is a screenshot comparing employee values in the system of FIG. 1, or other systems for valuating employees.

FIG. 8 is an illustration of a general computer system that may be used in the systems of FIG. 2, or other systems for valuating employees.

### DETAILED DESCRIPTION

A system and method, generally referred to as a system, may relate to valuating employees, and more particularly, but not exclusively, to determining an employee's net present value to an organization based on the predicted value of the employee to the organization over a time interval, such as five years, ten years, or the course of the employee's career. The principles described herein may be embodied in many different forms.

The system may allow an organization to identify its employees which may be the most valuable over a time interval into the future, such as five years, ten years, or generally any time interval. The system may provide the organization with a net present value of each employee which may account for the total expected value contributions of the employee over the time interval. The organization may use the net present value of an employee as a basis for retention, performance review, and/or succession targeting. In addition, the organization may wish to focus training, motivational and/or mentoring resources on the employees with the highest net present value, while not expending such resources on employees with the lowest net present value.

The system may allow organizations which are participating in a merger, or a restructuring, to evaluate the employees of each participating organization using a common metric. The common metric may be used to compare the employees of each organization in order to determine the employees which should be retained through the merger. For example, the organizations may have multiple personnel performing the same roles and may not wish to retain all of the personnel through the merger. However, the organizations may have distinct performance evaluation and review systems and therefore may not have an adequate metric for comparing the value of employees across each organization. The system may provide the organizations with a common, or normalized, metric which can be used to determine which of the employees should be retained through the merger.

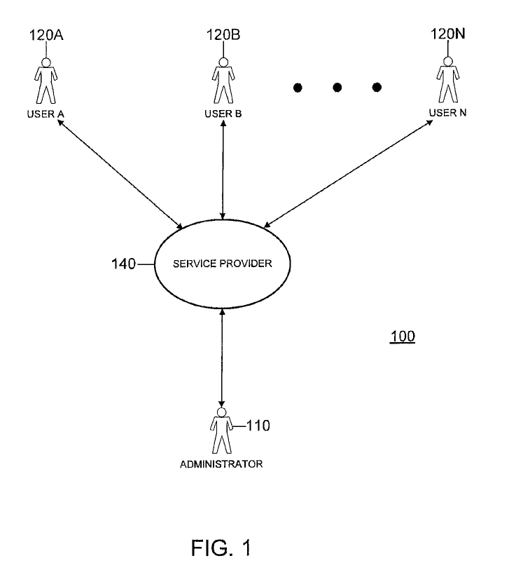

FIG. 1 provides a general overview of a system 100 for valuating employees. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more users 120A-N, an administrator 110, and a service provider 140. The users 120A-N may be employees of an organization who are responsible for making decisions regarding the organization's hiring and staffing needs. For example, the users 120A-N may be managers, human resource personnel, or generally any individuals involved in the hiring, training, retention, promotion, or evaluation of employees in an organization. Alternatively, the users 120A-N may be one or more consultants providing consulting services to the organization, such as human resource consulting services. The administrator 110 may maintain one or more data stores containing data describing employees of one or more organizations. The data may include employee demographic data, employee performance data, employee salary data, or generally any data describing the employees.

The service provider 140 may provide the users 120A-N with an employee valuation tool, such as through a standalone application, a network accessible web application, mobile application, or generally any computing application. For example, in the case of a standalone application, the employee valuation tool may be implemented in a spreadsheet, such as a MICROSOFT EXCEL spreadsheet. The users 120A-N may input employee performance data into the employee valuation tool, and the employee valuation tool may output a net present value of the employee based on the inputted performance data. The net present value of the employee may represent the expected value the employee will contribute to the organization over a time interval, such as five years, ten years, or the course of the employee's career.

The users 120A-N may perform one or more actions based on the net present value of each employee. For example, if an employee has a high net present value, the users 120A-N may devote additional organizational resources to the employee, such as training resources, mentoring resources, motivational resources, or generally any organizational resources. Alternatively, if an employee has a low net present value, the users 120A-N may redirect resources previously devoted to the employee. The resources may be redirected to one or more employees with a high net present value. The users 120A-N may also terminate the employment of an employee with a low net present value or may otherwise provide a warning to employees having a low net present value that they may be subject to termination if they do not increase their expected value to the organization over the time interval. Alternatively, the system 100 may provide employees with a low net present value with one or more recommendations for increasing their net present value.

The service provider 140 may provide the employee valuation tool to the users 120A-N. The service provider 140 may store one or more input values which describe the employees of the organization, such as performance reviews, salary changes, promotion history, or other metrics indicative of the employees' value to the organization. The service provider 140 may automatically retrieve employee data from a database of the organization, such as through an application programming interface (API). Alternatively, one of the users 120A-N may input employee data to the service provider 140. For example, the service provider 140 may provide an interface for inputting the employee data. Alternatively, the service provider 140 may provide a bulk upload tool to the users 120A-N, which may allow the users 120A-N to upload a data file containing employee data, such as a flat file, a text file, a comma separated values (CSV) file, or generally any data file.

The administrator 110 may maintain the databases storing the employee data which are utilized by the employee valuation tool. For example, the service provider 140 may provide an interface to the administrator 110, or other authorized users, for maintaining the databases. The administrator 110 may also modify configurable aspects of the employee valuation tool. For example, the administrator may be able to configure the look and feel of the employee valuation tool and/or may be able to configure variables related to the performance of the employee valuation tool.

In operation, the administrator 110, or one of the users 120A-N, may provide the service provider 140 with data describing the performance of the employees of an organization over a time interval, such as five years, ten years, or generally any time interval. The data may include variables which are indicative of a long term value of an employee, as opposed to variables indicative of a short term value of an employee. For example, the data may include rate of salary change over time, count of promotions over time, count of change in functional areas over time, or generally any data which may be indicative of the overall value of the employees over the entire time interval, as opposed to variables which may only be indicative of the value of the employee for a part of the time interval.

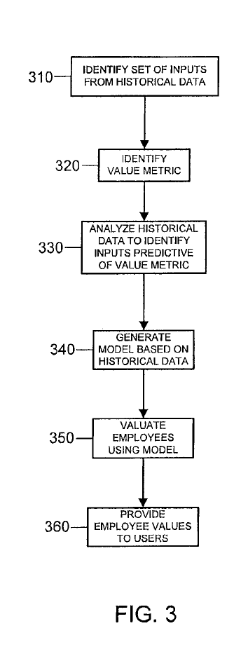

The administrator 110, or one of the users 120A-N, may identify a value metric which is indicative of the employees which have been identified as valuable to the organization. For example, the users 120A-N may rank the employees from most valuable to least valuable, or the users 120A-N may assign a score to each employee, such as on a scale of one to one hundred, based on the employee's determined value to the organization. The value of the employees may be subjective and may vary from organization to organization. Alternatively, if the users 120A-N are unable to rank or otherwise identify a value metric for all of the employees, the users 120A-N may identify only the most valuable employees. The service provider 140 may analyze the performance data of the employees who were identified as valuable in order to determine one or more performance values which are indicative of the value metric. For example, the service provider 140 may use clustering techniques, regression analysis, or other statistical data analysis techniques, to identify one or more performance values which are indicative of the value metric. The service provider 140 may then process the identified performance values in order to generate a predictive model, such as a naïve Byes model, a k-nearest neighbor algorithm, a majority classifier, a support vector machine, a logistic regression model, an uplift model, or generally any predictive model. The predictive model may take the employee performance data as inputs and may generate a net present value indicative of the expected value of each employee to the organization over a time interval, such as five years, ten years, or the course of the employee's career. Alternatively or in addition, the predictive model may generate a probability of the employee having a high value, a low value, or generally any categorization of employee value. The generation of the predictive model is discussed in more detail in FIG. 3 below.

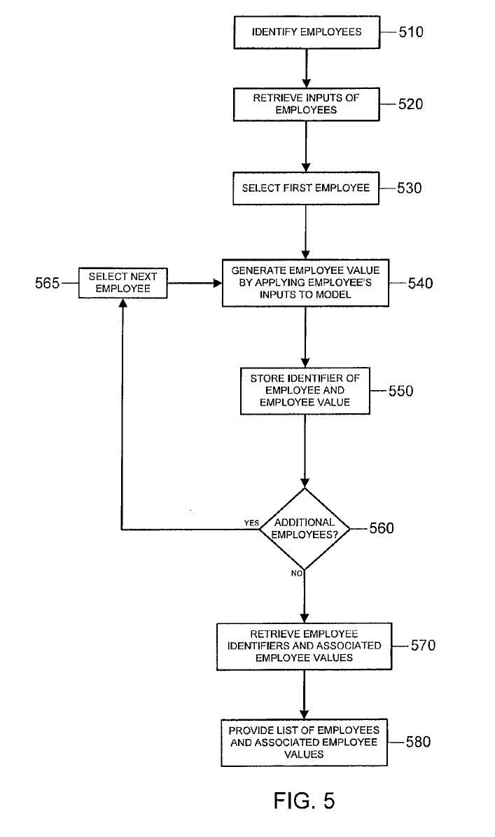

The service provider 140 may apply the performance values of each employee as an input to the predictive model in order to generate a net present value of each employee of the organization. The service provider 140 may provide the values to one or more of the users 120A-N, such as through a graphical interface. The graphical interface may display the net present value of each employee as a numerical value or as a graphical representation indicative of the numerical value, such as a number of stars. Alternatively, the net present value of the users 120A-N may be transformed into a graphical display, such as a bar graph, a linear graph, a three-dimensional graph, or generally any graphical output capable of representing the net present values of the employees. The users 120A-N may use the net present values of the employees to prioritize organizational resources to the most valuable employees. The users 120A-N may further use the net present values for performance evaluations and/or to ensure the retention of the most valuable employees. Conversely, the users 120A-N may terminate the employment of the least valuable employees, or otherwise warn the least valuable employees that their employment may be terminated. Alternatively or in addition, for the least valuable employees, the service provider 140 may identify one or more business units where the employees may be moved to which may increase the net present value of the employees. Providing the employee net present values is discussed in more detail in FIG. 5 below.

The service provider 140 may also generate one or more weights for the employee net present values. The weights may be used to normalize the employee net present values such that the employee net present values can be used as inputs to other processes. For example, the employee net present values may be used as inputs in incentive processes, performance review processes, retention processes, termination processes, or generally any other processes which may utilize from the employee net present values. Alternatively or in addition the weights may be used to compare the net present values of employees across multiple organizations. For example, in the case of multiple organizations participating in a merger, the weights may be used to normalize the net present values of the employees of each organization such that the employees of each organization can be compared against each other using a common metric.

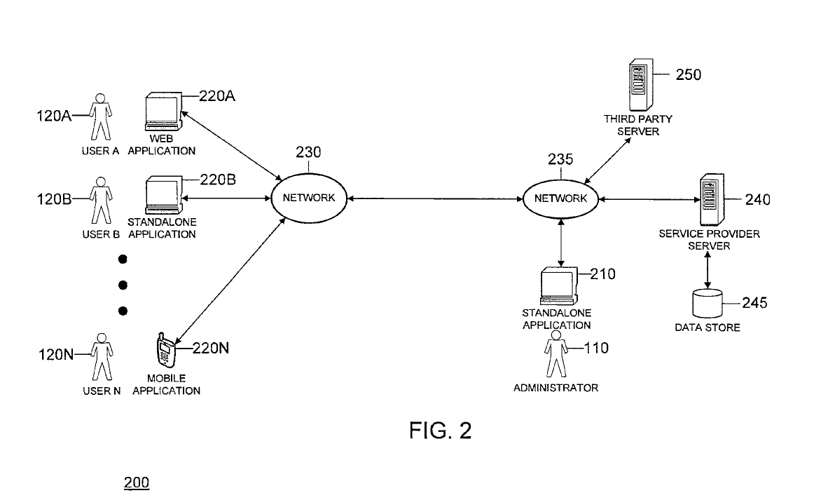

FIG. 2 provides a simplified view of a network environment 200 implementing the system of FIG. 1 or other systems for valuating employees. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 200 may include one or more users 120A-N, an administrator 110, a service provider server 240, a third party server 250, a data store 245, networks 230, 235, and one or more web applications, standalone applications, mobile applications 210, 220A-N, which may collectively be referred to as client applications. Some or all of the service provider server 240 and the third party server 250 may be in communication with each other by way of network 235.

The networks 230, 235 may include wide area networks (WAN), such as the Internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The web applications, standalone applications and mobile applications 210, 220A-N may be connected to the network 230 in any configuration that supports data transfer. This may include a data connection to the network 230 that may be wired or wireless. Any of the web applications, standalone applications and mobile applications 210, 220A-N may individually be referred to as a client application. The web application 220A may run on any platform that supports web content, such as a web browser or a computer, a mobile phone, personal digital assistant (PDA), pager, network-enabled television, digital video recorder, such as TIVO®, automobile and/or any appliance or platform capable of data communications. The web application 220A may support a rich internet application implemented with the ADOBE FLEX® technologies. Alternatively or in addition the web application 220A may be developed using one or more of the following technologies: ADOBE FLEXBUILDER 3®, ADOBE FLEX SUBCLIPSE®, or generally any web development technologies.

The standalone application 220B may run on a machine that may have a processor, memory, a display, a user interface and a communication interface. The processor may be operatively connected to the memory, display and the interfaces and may perform tasks at the request of the standalone application 220B or the underlying operating system. The memory may be capable of storing data. The display may be operatively connected to the memory and the processor and may be capable of displaying information to the user B 120B. The user interface may be operatively connected to the memory, the processor, and the display and may be capable of interacting with a user B 120B. The communication interface may be operatively connected to the memory, and the processor, and may be capable of communicating through the networks 230, 235 with the service provider server 240. The standalone application 220B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, ADOBE FLEX®, amongst others.

The mobile application 220N may run on any mobile device that may have a data connection. The data connection may be a cellular connection, a wireless data connection, an internet connection, an infra-red connection, a Bluetooth connection, or any other connection capable of transmitting data. For example, the mobile application 220N may be an application running on an APPLE IPHONE®.

The service provider server 240 may include one or more of the following: an application server, a mobile application server, a data store, a database server, and a middleware server. The service provider server 240 may exist on one machine or may be running in a distributed configuration on one or more machines. The service provider server 240 may be in communication with the client applications 210, 220A-N, such as over the networks 230, 235. For example, the service provider server 240 may provide a user interface to the users 120A-N through the client applications 220A-N, such as a user interface for inputting employee data and/or viewing employee net present values. Alternatively or in addition, the service provider server 240 may provide a user interface to the administrator 110 via the client application 210, such as a user interface for managing the data source 245 and/or configuring the employee valuation tool.

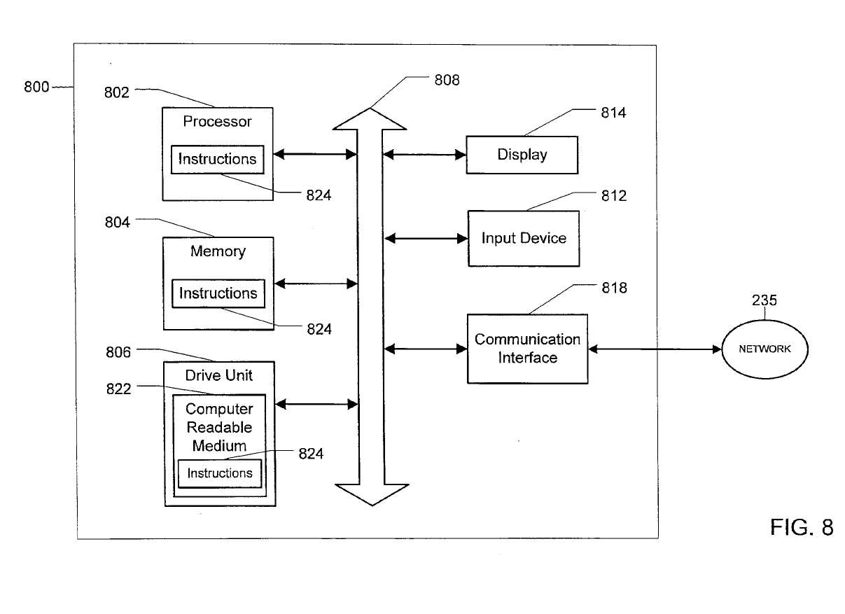

The service provider server 240 and client applications 210, 220A-N may be one or more computing devices of various kinds, such as the computing device in FIG. 8. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 220A may employ the Hypertext Transfer Protocol (“HTTP”) to request information, such as a web page, from a web server, which may be a process executing on the service provider server 240.

There may be several configurations of database servers, application servers, mobile application servers, and middleware applications included in the service provider server 240. The data store 245 may be part of the service provider server 240 and may be a database server, such as MICROSOFT SQL SERVER®, ORACLE®, IBM DB2®, SQLITE®, or any other database software, relational or otherwise. The application server may be APACHE TOMCAT®, MICROSOFT ITS®, ADOBE COLDFUSION®, or any other application server that supports communication protocols.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

FIG. 3 is a flowchart illustrating the generation of a predictive model for valuating employees in the system of FIG. 1 or other systems for valuating employees. The steps of FIG. 3 are described as being performed by the service provider server 240. However, the steps may be performed by the processor of the service provider server 240, or by any other hardware component of the service provider server 240. Alternatively the steps may be performed by an external hardware component.

At step 310, the service provider server 240 identifies a set of inputs from historical employee performance data over a time interval, such as five years, ten years, or generally any time interval. The set of inputs may be one or more data points describing the performance of the employees, such as rate of salary change over time, count of promotions over time, count of functional areas over time, or any similar metrics. For example, one of the users 120A-N, or the administrator 110, may provide the historical employee data to the service provider server 240 via the client applications 210, 220A-N. At step 320, the service provider server 240 may identify a value metric describing the value contributed by the employees over the time interval. For example, the value metric may be an employee ranking, an employee score, or generally any metric indicative of the value contributed by the employees. The value metric may be one of the inputs in the historical employee data, or may be a new set of values identified by the service provider server 240. In one example, one of the users 120A-N, or the administrator 110, may provide the value metric to the service provider server 240, such as by inputting the value metric into a user interface. The value metric may indicate the value of each employee to the organization over the time interval represented by the employee performance data.

At step 330, the service provider server 240 may analyze the historical data to identify the inputs which are predictive of the value metric over the time interval. For example, some of the inputs may be indicative of the overall value contributed by the user over the course of the time interval, or period of time, while other inputs may only be indicative of the value contributed by the user for a part of the time interval. For example, the service provider server 240 may use clustering techniques, regression analysis, or other statistical techniques to analyze the historical data of employees who have a high value metric. Alternatively, the service provider server 240 may use data analysis techniques to analyze the historical data of employees having a low value metric.

At step 340, the service provider server 240 may generate a predictive model using the inputs determined at step 330. At step 350, the service provider server 240 may generate a net present value for each employee using the generated predictive model. The net present values may be indicative of whether or not each employee will be valuable to the organization over the course of a time interval, such as five years, ten years, or generally any time interval. For example, the current performance data of each employee may be provided to the predictive model, and the predictive model may output a value indicative of the net present value of the employee. In one example, the net present value of the employee may be a likelihood that the employee will have a high value over the course of the employee's career. For example, if the inputs of the employee are similar to the inputs of employees known to have a high value metric over a time interval, such as five years, then there may be a high likelihood that the employee will also have a high value over a similar time interval, such as the next five years. At step 360, the service provider server 240 may provide the net present value of the employees to the users 120A-N, such as through a user interface.

Alternatively or in addition, one of the users 120A-N, such as the user A 120A, may review the employee net present values generated by the predictive model to verify that the values correspond to the observations of the user A 120A. If the values produced by the predictive model do not correspond to the observations of the user A 120A, the user A 120A may modify the employee net present values and regenerate the predictive model based on the modified employee net present values. The regenerated predictive model should produce values which are consistent with the observations of the user A 120A.

Alternatively or in addition, after the time interval represented by the employee net present value elapses, one of the users 120A-N, such as the user A 120A, may compare the employee net present values generated at step 350 with the actual value contributed by the employees over the time interval. If any of the actual values differ from the employee net present values generated at step 350, the user A 120A may regenerate the predictive model based on the actual values.

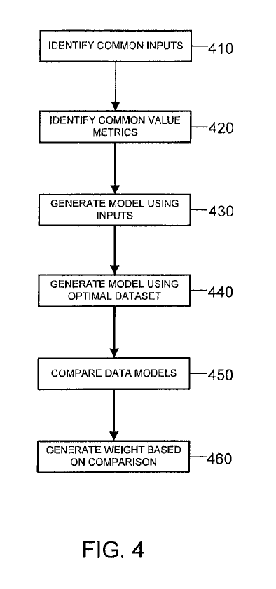

FIG. 4 is a flowchart illustrating the generation of employee value weightings in the system of FIG. 1, or other systems for valuating employees. The steps of FIG. 4 are described as being performed by the service provider server 240. However, the steps may be performed by the processor of the service provider server 240, or by any other hardware component of the service provider server 240. Alternatively the steps may be performed by an external hardware component.

At step 410, the service provider server 240 may identify historical data inputs that are common across multiple organizations. For example, inputs which may be common across multiple organizations may include a number of promotions over time, a percentage of salary raise over time, the number of roles an employee has had over time, or other similar metrics. At step 420, the service provider server 240 may identify value metrics which may be common across multiple organizations and may be indicative of a successful employee. For example, the service provider server 240 may identify employees who have been promoted the fastest in an organization, employees who have had the highest rate of salary change, or generally any metric which may be indicative of a valuable employee. At step 430, the service provider server 240 may generate a predictive model using the common historical inputs which are indicative of the common value metric for an organization.

At step 440, the service provider server 240 may generate a second predictive model using employee input data and a value metric particular to one organization. Since the second predictive model is generated using the dataset of a particular organization, it may provide the most accurate employee net values for the particular organization. At step 450, the service provider server 240 may apply employee input data to both the common predictive model and the organization specific predictive model to generate an employee net present value for each predictive model. The employee net present values generated by each predictive model may be compared to determine a weighting which equates the values generated by the organization specific model to the values generated by the common model. The service provider server 240 may generate a weight for each organization such that the service provider server 240 may use the common predictive model, plus a set of weights for each organization, to determine the employee net present value of employees of each organization which may be approximately equivalent to the employee net present values generated by the organization specific model.

FIG. 5 is a flowchart illustrating the generation of predictive employee values in the system of FIG. 1, or other systems for valuating employees. The steps of FIG. 5 are described as being performed by the service provider server 240. However, the steps may be performed by the processor of the service provider server 240, or by any other hardware component of the service provider server 240. Alternatively the steps may be performed by an external hardware component.

At step 510, the service provider server 240 identifies one or more employees of an organization. For example, the administrator 110 or one of the users 120A-N may provide a set of employees of an organization, and data describing the performance employees, to the service provider server 240. At step 520, the service provider server 240 may retrieve the inputs of the employees, or the data describing the employees, such as from the data store 245. At step 530, the service provider server 240 may select the first employee from the set of employees. At step 540, the service provider server 240 may apply inputs of the employee's data to the predictive model to generate a net present value of the employee. At step 550, the service provider server 240 may store an identifier of the employee, and the net present value of the employee in a data store, such as the data store 245.

At step 560, the service provider server 240 determines whether there are additional employees in the set of employees. If, at step 560, the service provider server 240 determines there are additional employees in the set of employees, the service provider server 240 moves to step 565. At step 565, the service provider server 240 selects the next employee in the set of employees and repeats steps 540-560 with the next employee.

If, at step 560, the service provider server 240 determines there are no additional employees in the set of employees, the service provider server 240 moves to step 570. At step 570, the service provider server 240 retrieves the employee identifiers and the associated employee net present values, such as from the data store 245. At step 580, the service provider server 240 provides a list of the employees, and the associated employee net present values, such as to one of the users 120A-N. For example, the service provider server 240 may provide the list of the employees and associated employee net present values to one of the users 120A-N through a web page. Alternatively or in addition, the service provider server 240 may transform the employee net present values into a graphical display and may provide the graphical display to one of the users 120A-N. For example, the service provider server 240 may transform the values into a bar graph, a pie chart, or generally any graphical display capable of representing the values.

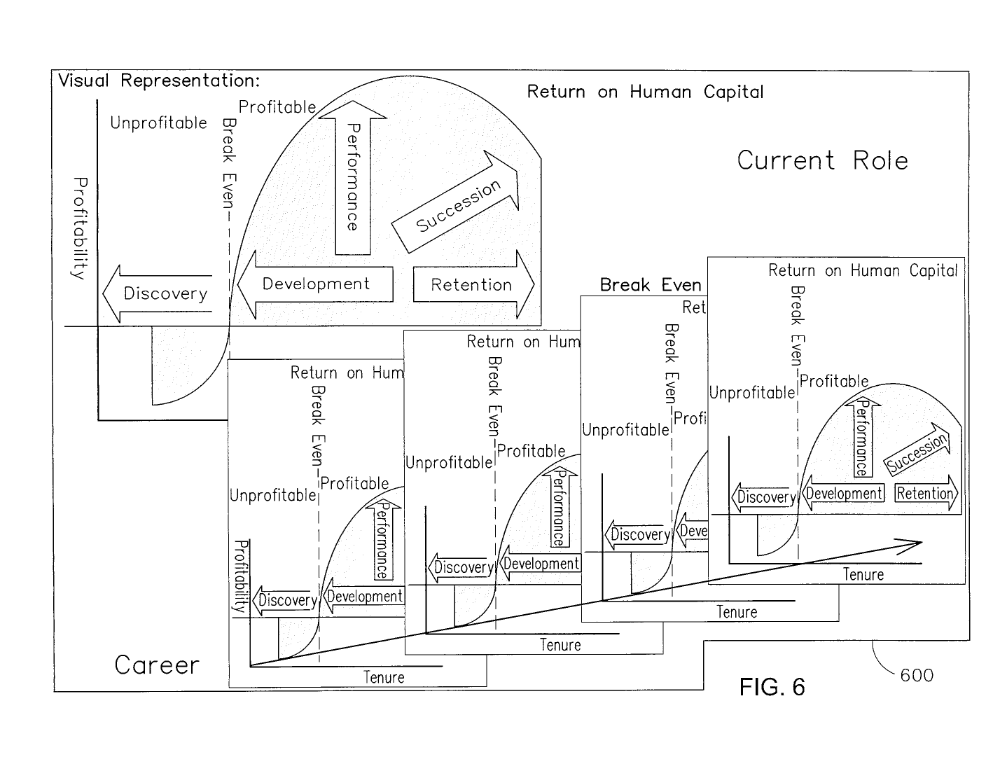

FIG. 6 is a graph 600 demonstrating employee value points in the system of FIG. 1, or other systems for valuating employees. The graph 600 may include a profitable quadrant 610, and an unprofitable quadrant 620. The graph 600 demonstrates that the value of an employee to an organization may increase over the course of the employee's career.

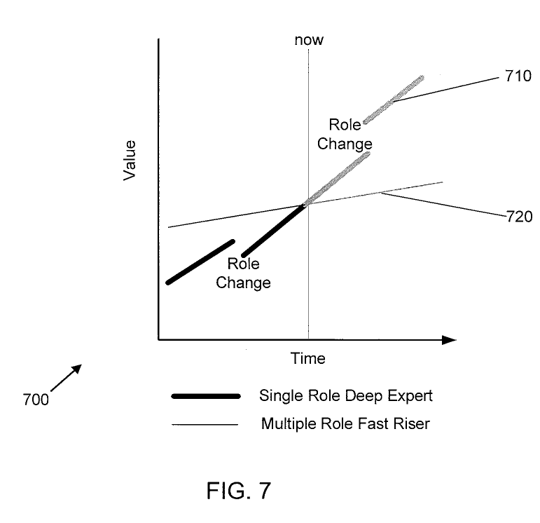

FIG. 7 is a screenshot of an interface 700 for comparing employee values in the system of FIG. 1, or other systems for valuating employees. The interface 700 may include a first employee line 710 and a second employee line 720. The interface 700 may be provided to a user A 120A by the service provider server 240 after the service provider server 240 generates employee net present values for one or more employees.

The first employee line 710 indicates that the value contributed by the first user to the organization will increase steadily over the course of the career of the first employee. The value contributed by the employee may increase due to the employee changing roles within the organization. The second employee line 720 indicates that the value contributed by the second user to the organization may be approximately constant over the course of the career of the second employee. The second employee may maintain the same role over the course of their career, which may result in less value contributed to the organization. Thus, the organization may wish to focus organizational resources on developing the first employee as opposed to the second employee.

FIG. 8 illustrates a general computer system 800, which may represent a service provider server 240, or any of the other computing devices referenced herein. The computer system 800 may include a set of instructions 824 that may be executed to cause the computer system 800 to perform any one or more of the methods or computer based functions disclosed herein. The computer system 800 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 824 (sequential or otherwise) that specify actions to be taken by that machine. In a particular embodiment, the computer system 800 may be implemented using electronic devices that provide voice, video or data communication. Further, while a single computer system 800 may be illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, such as, a central processing unit (CPU), a graphics processing unit (GPU), or both. The processor 802 may be a component in a variety of systems. For example, the processor 802 may be part of a standard personal computer or a workstation. The processor 802 may be one or more general processors, digital signal processors, application specific integrated circuits, field programmable gate arrays, servers, networks, digital circuits, analog circuits, combinations thereof, or other now known or later developed devices for analyzing and processing data. The processor 802 may implement a software program, such as code generated manually (i.e., programmed).

The computer system 800 may include a memory 804 that can communicate via a bus 808. The memory 804 may be a main memory, a static memory, or a dynamic memory. The memory 804 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 804 may include a cache or random access memory for the processor 802. Alternatively or in addition, the memory 804 may be separate from the processor 802, such as a cache memory of a processor, the system memory, or other memory. The memory 804 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 804 may be operable to store instructions 824 executable by the processor 802. The functions, acts or tasks illustrated in the figures or described herein may be performed by the programmed processor 802 executing the instructions 824 stored in the memory 804. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 800 may further include a display 814, such as a liquid crystal display (LCD), an organic light emitting diode (OLED), a flat panel display, a solid state display, a cathode ray tube (CRT), a projector, a printer or other now known or later developed display device for outputting determined information. The display 814 may act as an interface for the user to see the functioning of the processor 802, or specifically as an interface with the software stored in the memory 804 or in the drive unit 806.

Additionally, the computer system 800 may include an input device 812 configured to allow a user to interact with any of the components of system 800. The input device 812 may be a number pad, a keyboard, or a cursor control device, such as a mouse, or a joystick, touch screen display, remote control or any other device operative to interact with the system 800.

The computer system 800 may also include a disk or optical drive unit 806. The disk drive unit 806 may include a computer-readable medium 822 in which one or more sets of instructions 824, e.g. software, can be embedded. Further, the instructions 824 may perform one or more of the methods or logic as described herein. The instructions 824 may reside completely, or at least partially, within the memory 804 and/or within the processor 802 during execution by the computer system 800. The memory 804 and the processor 802 also may include computer-readable media as discussed above.

The present disclosure contemplates a computer-readable medium 822 that includes instructions 824 or receives and executes instructions 824 responsive to a propagated signal; so that a device connected to a network 235 may communicate voice, video, audio, images or any other data over the network 235. Further, the instructions 824 may be transmitted or received over the network 235 via a communication interface 818. The communication interface 818 may be a part of the processor 802 or may be a separate component. The communication interface 818 may be created in software or may be a physical connection in hardware. The communication interface 818 may be configured to connect with a network 235, external media, the display 814, or any other components in system 800, or combinations thereof. The connection with the network 235 may be a physical connection, such as a wired Ethernet connection or may be established wirelessly as discussed below. Likewise, the additional connections with other components of the system 800 may be physical connections or may be established wirelessly. In the case of a service provider server 240, the service provider server may communicate with users 120A-N through the communication interface 818.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 822 may be a single medium, or the computer-readable medium 822 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 822 may include a solid-state memory such as a memory card or other package that houses one or more non-volatile read-only memories. The computer-readable medium 822 also may be a random access memory or other volatile re-writable memory. Additionally, the computer-readable medium 822 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method for determining employee net present value, the method comprising:
receiving a historical dataset describing a plurality of employees of a first organization, wherein the historical dataset comprises a plurality of inputs describing a performance of each employee of the plurality of employees over a time interval;
identifying a first value metric, wherein the first value metric describes an overall value contributed by each employee to the first organization over the time interval;
analyzing the historical dataset to identify a subset of the plurality of inputs which are indicative of the first value metric over the time interval;
generating, by one or more processors, a predictive model based on the subset of the plurality of inputs and the first value metric, the predictive model for determining a net present value of each employee; and
generating the net present value of each employee by applying the plurality of inputs of each employee to the predictive model, wherein the net present value of each employee is indicative of an expected value to be contributed by each employee over the course of a future time interval equivalent to the time interval.

2. The method of claim 1 further comprising providing, to an electronic device, the net present value of each employee.

3. The method of claim 2 wherein the net present value of each employee is provided to the electronic device through a web page.

4. The method of claim 1 wherein an input of the plurality of inputs comprises at least one of a rate of salary change over time, a count of promotions over time, or a count of functional areas over time.

5. The method of claim 1 wherein the first value metric comprises a salary of each employee.

6. The method of claim 1 further comprising:
receiving a second historical dataset describing a second plurality of employees, wherein the second historical dataset comprises a second plurality of inputs; and
adjusting the predictive model based on the second plurality of inputs.

7. The method of claim 1, wherein the predictive model is a common model operable to generate a common model net present value of each employee of the first and second organizations;
receiving a second historical dataset describing a second plurality of employees of the second organization, wherein the second historical dataset comprises a second plurality of inputs; and
identifying a second value metric, where the first value metric is common across the first organization and a second organization, where the second value metric is particular to the second organization;
generating, by the one or more processors, an organization specific model based on the second plurality of inputs and the second value metric, the organization specific model for determining an organization specific model net present value of each employee of the second organization;
generating an organization specific model net present value of each employee of the first organization by applying the plurality of inputs of each employee to the organization specific model; and
determining a common model weight for the first organization by comparing the common model net present value of each employee of the first organization with the organization specific model net present value of each employee of the first organization, wherein the common model net present value plus the common model weight together equal the organization specific model net present value.

8. A system for valuating employees, the system comprising:
means for receiving a historical dataset describing a plurality of employees of an organization, wherein the historical dataset comprises a plurality of inputs describing a performance of each employee of the plurality of employees over a time interval;
means for identifying a value metric, wherein the value metric describes an overall value contributed by each employee to the organization over the time interval;
means for analyzing the historical dataset to identify a subset of the plurality of inputs which are indicative of the value metric over the time interval; and
means for generating, by one or more processors, a predictive model based on the subset of the plurality of inputs and the value metric, the predictive model for determining a net present value of each employee, wherein the net present value of each employee is indicative of an expected value to be contributed by each employee over the course of a future time interval equivalent to the time interval.

9. The system of claim 8 further comprising means for applying the plurality of inputs of each employee to the predictive model to generate the net present value of each employee.

10. The system of claim 9 further comprising means for providing, to an electronic device, the net present value of each employee.

11. The system of claim 10 wherein the net present value of each employee is provided to the electronic device through a web page.

12. The system of claim 8 wherein an input of the plurality of inputs comprises at least one of a rate of salary change over time, a count of promotions over time, or a count of functional areas over time.

13. The system of claim 8 wherein the value metric comprises a salary of each employee.

14. The system of claim 8 further comprising:
means for receiving a second historical dataset describing a second plurality of employees, wherein the second historical dataset comprises a second plurality of inputs; and
means for adjusting the predictive model based on the second plurality of inputs.

15. A system for valuating employees, the method comprising:
a memory operative to store a historical dataset describing a plurality of employees of an organization, wherein the historical dataset comprises a plurality of inputs describing a performance of each employee of the plurality of employees over a time interval; and
a processor, operative connected to the memory, the processor operative to receive the historical dataset, identify a value metric, wherein the value metric describes an overall value contributed by each employee to the organization over the time interval, analyze the historical data to identify a subset of the plurality of inputs which are indicative of the value metric, and generate a predictive model based on the subset of the plurality of inputs and the value metric, the predictive model for determining a net present value of each employee, wherein the net present value of each employee is indicative of an expected value to be contributed by each employee over the course of a future time interval equivalent to the time interval.

16. The system of claim 15 wherein the processor is further operative to apply the plurality of inputs of each employee to the predictive model to generate the net present value of each employee.

17. The system of claim 15 wherein the processor is further operative to provide, to an electronic device, the net present value of each employee.

18. The system of claim 17 wherein the processor is further operative to provide the net present value of each employee to the electronic device through a web page.

19. The system of claim 15 wherein an input of the plurality of inputs comprises at least one of a rate of salary change over time, a count of promotions over time, or a count of functional areas over time.

20. The system of claim 15 wherein the value metric comprises a salary of each employee.
